(19) United States
(12) Patent Application Publication
(10) Pub. No.: US 2008/0080059 A1
(43) Pub. Date: Apr. 3, 2008

(54) MODULAR OPTICAL COMPONENTS AND SYSTEMS INCORPORATING SAME

(75) Inventors: John Dixon, Moss Beach, CA (US); Paul Lundquist, San Jose, CA (US)

Correspondence Address: MORGAN, LEWIS & BOCKIUS LLP (SF), 2 PALO ALTO SQUARE, 3000 El Camino Real, Suite 700, PALO ALTO, CA, 94306, US

(73) Assignee: Pacific Biosciences of California, Inc., Menlo Park, CA (US)

(21) Appl. No.: 11/863,058

(22) Filed: Sep. 27, 2007

Related U.S. Application Data
(60) Provisional application No. 60/847,867, filed on Sep. 28, 2006.

(51) Int. Cl. G02B 27/14

(52) U.S. Cl. 359/629

(57) ABSTRACT

Modular optical systems employing integrated optical plates, prisms, reflective and semireflective layers that provide less complex, more robust optical systems. The modular systems provide single, or double component optical modules for the redirection, deflection and separation of optical energy for use in optical systems, and particularly optical detection systems for, e.g., fluorescence analysis tools used in the biochemical and chemical analysis industries.

### CROSS-REFERENCE TO RELATED APPLICATIONS

This application claims priority to Provisional U.S. Patent Application No. 60/847,867, filed on Sep. 28, 2006, the full disclosure of which is incorporated herein by reference in its entirety for all purposes.

### STATEMENT REGARDING FEDERALLY SPONSORED RESEARCH

Not applicable.

### BACKGROUND OF THE INVENTION

A large number of systems directed at the optical analysis of samples or materials employ complex optical trains that direct, focus, filter, split, separate and detect light to and/or from the sample materials. Such systems typically employ a number of different elements to achieve the various aspects of foregoing and devote a reasonable amount of space and cost to such components. For example, typical systems employ mirrors and prisms in directing light from its source(s) to a desired destination. Additionally, such systems may include light splitting optics such as beam splitting prisms to generate two beams from a single original beam. Where more beams are desired, each beam is iteratively split using a cascading set of beam splitters. While the foregoing systems have proven useful in their applications, there is always room to improve upon the functionality, footprint and cost of such systems. The present invention meets these and a variety of other needs.

### BRIEF SUMMARY OF THE INVENTION

The present invention is directed to simplified and robust optical components for use in redirecting, deflecting and/or multiplexing optical systems, as well as to the systems that incorporate these components. The components of the invention typically comprise modular optical components (also referred to herein as “optical modules”) in the form of optical plates, prisms or combinations of these that serve to manipulate light without the need for excessively complicated systems of mirrors and lenses, and do so in a manner that prevents or minimizes optical aberrations.

In a preferred aspect, the invention provides an optical module. This optical module comprises a first optical component configured to redirect a beam of light passed there through. This first optical component has a first chromatic separation characteristic. The optical module in this aspect of the invention also comprises a second optical component adjacent the first optical component. The second optical component has a second chromatic separation characteristic that is complementary to the first chromatic separation characteristic, such that chromatic separation of the beam of light imparted by the first chromatic separation characteristic of the first optical component is substantially eliminated by the second chromatic separation characteristic of the second optical component.

In another aspect, the invention provides an optical system. In this aspect, the optical system comprises an illumination light source and an analytical substrate. The optical system also comprises an optical train configured to direct illumination light from the illumination light source to at least a first location on the analytical substrate. In this aspect, the optical train comprises a first optical component configured to redirect a beam of light from the illumination light source directed through the first optical component. The first optical component has a first chromatic separation characteristic. The optical train also comprises a second optical component adjacent the first optical component, and the second optical component has a second chromatic separation characteristic that is complementary to the first chromatic separation characteristic, such that chromatic separation of the beam of light imparted by the first chromatic separation characteristic of the first optical component is substantially eliminated by the second chromatic separation characteristic of the second optical component.

In still another aspect, the invention provides an optical module, which comprises a first variable reflective surface and a first mirrored surface spaced from and opposing the first variable reflective surface. In this aspect of the invention, when a first light beam is directed at a first position upon the first variable reflective surface, a portion of the light beam is reflected from the variable reflective surface to the mirrored surface and reflected back from the mirrored surface in a second beam to the variable reflective surface at a second position, and a portion of the first beam and second beams are transmitted through the variable reflective surface in first and second emanating beams. In this aspect of the invention, the first and second emanating beams are of substantially the same intensity.

In another aspect, the invention provides an optical system, which comprises an illumination light source and an analytical substrate. The optical system of this aspect of the invention also comprises an optical train configured to direct illumination light from the illumination light source to a plurality of locations on the analytical substrate. The optical train Comprises an optical module, and this optical module in turn comprises a first variable reflective surface and a first mirrored surface spaced from and opposing the first variable reflective surface. In this aspect of the invention, a first light beam from the illumination light source is directed at a first position upon the first variable reflective surface, a portion of the light beam is reflected from the variable reflective surface to the mirrored surface and reflected back from the mirrored surface in a second beam to the variable reflective surface at a second position, and a portion of the first beam and second beams are transmitted through the variable reflective surface in first and second emanating beams. The first and second emanating beams are of substantially the same intensity and are directed at the plurality of locations on the analytical substrate.

In yet another aspect, the invention provides a method of achromatically redirecting a path of a light beam. In this aspect, the method includes the step of directing the light beam through a first optical component that is configured to redirect the light beam by a first deflection angle to yield a first deflected light beam, wherein the first optical component has a first chromatic separation characteristic. This method also includes the step of directing the first deflected light beam through a second optical component adjacent the first optical component. The second optical component has a second chromatic separation characteristic that is complementary to the first chromatic separation characteristic, such that chromatic separation of the deflected light beam imparted by the first chromatic separation characteristic of the first optical component is substantially eliminated by the second chromatic separation characteristic of the second optical component, to yield a second deflected light beam.

In another aspect, the invention provides a method of multiplying a first light beam into a plurality of light beams. In this aspect, the method includes the step of directing the first light beam through a first optical component that comprises a first variable reflective surface and a first mirrored surface spaced from and opposing the first variable reflective surface. When the first light beam is directed at a first position upon the first variable reflective surface, a portion of the first light beam is reflected from the variable reflective surface to the mirrored surface and reflected back from the mirrored surface in a second beam to the variable reflective surface at a second position, and a portion of the first beam and second beams are transmitted through the variable reflective surface in first and second emanating beams. In this aspect of the invention, the first and second emanating beams are of substantially the same intensity.

### BRIEF DESCRIPTION OF THE DRAWINGS

FIG. 1 is a schematic illustration of mirror-based optical components used in the redirection and/or angular deflection of light in optical systems.

FIG. 2 is a schematic illustration of a prism based component used in redirection of light in optical systems and a schematic representation of chromatic aberrations that may result.

FIG. 3 is a schematic illustration of a multiprism optical component(s) for use in light redirection/deflection without imparting chromatic aberrations.

FIG. 4 is an illustration of an exemplary two prism system used to generate optical deflection without imparting chromatic aberrations to the resulting beam.

FIG. 5A schematically illustrates an optical plate based component for redirection of light with potential consequent chromatic separation. FIG. 5B illustrates a multiple plate system that corrects for such chromatic separation.

FIG. 6 schematically illustrates a dual plate modular beam splitter for generating multiple output beams from a single input beam.

FIG. 7 schematically illustrates a similar beam splitter to that shown in FIG. 6, but having the functionality integrated into a single plate component.

FIG. 8 schematically illustrates a monolithic block configuration of the beam splitter shown in FIG. 7.

FIG. 9 schematically illustrates an optical system into which the components of the invention are optionally integrated.

FIG. 10 schematically illustrates alternate configurations of a beam multiplication component of the invention.

### DETAILED DESCRIPTION OF THE INVENTION

The present invention is generally directed to simplified optical components and optical systems that include such simplified components. By incorporating such components into overall systems, advantages of cost, robustness and overall simplicity are achieved.

In particular, conventional optical components required to direct and manipulate light in optical systems can involve complex collections of potentially expensive precision optical components to accomplish seemingly minor goals. For example, in directing light beams, mirrors are typically used. Unfortunately, use of such mirrors typically either requires large angle deflections, or multiple serial mirrors precisely arranged, to accomplish minor angles of deflection. Such systems are therefore, either ineffective for certain goals, and/or potentially expensive, complex, and prone to misalignment.

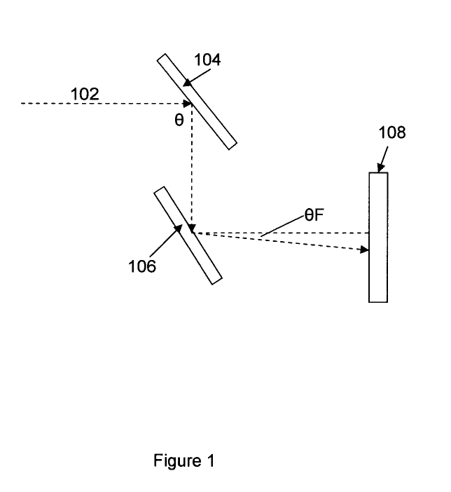

The foregoing aspect of mirror based deflection systems is schematically illustrated in FIG. 1. As shown, an applied light beam, shown as arrow 102, is directed at mirror 104 to achieve beam deflection. However, in order to avoid substantial distortion of the resulting beam spot shape and size, the angle of deflection (θ) is relatively large, e.g., on the order of 90° or more. As a result, redirection of optical paths using a single mirror requires the ability to accommodate the space constraints associated with such an approach, e.g., accommodating the beam's destination substantially at a right angle to the light source. Alternatively, and as shown in FIG. 1, a second or other additional mirror may be employed to achieve smaller ultimate angles of deflection from the original beam's axis. For example, second mirror 106 may be employed to redirect the light beam a second time to provide an ultimate or net angle of deflection (θ_{F}) that is as small or large as desired, to provide the incident beam on the desired substrate 108 or other destination.

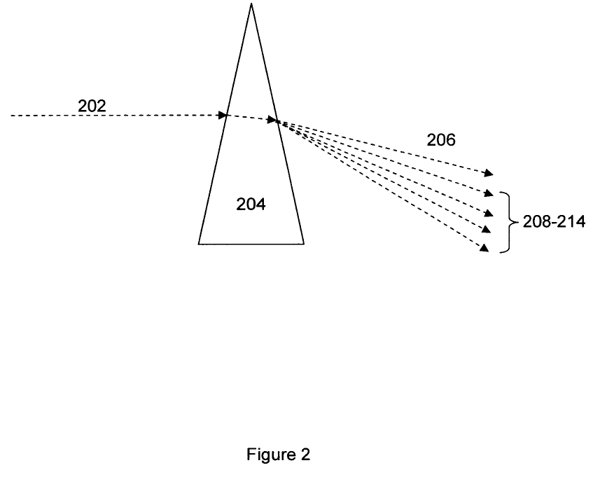

Alternative systems have employed prisms as the light directing component. For example, narrow wedge prisms have also been used to achieve small angles of deflection, as shown in FIG. 2. In particular, the light beam 202 is directed through a prism 204 to yield a deflected beam 206. Unfortunately, in the case of broader spectrum light beams, or multiple different beams of different wavelengths, the ultimate beam or beams will typically be spectrally separated as a result of the differing dispersion of the spectral components of the transmitted beam or beams, as indicated by arrows 208-214. Where one wishes to deflect broader spectrum light beams achromatically, or multiple different narrow band beams at similar or identical angles of deflection, this differential spectral deflection can create substantial problems. This is in contrast to circumstances where color based beam or signal separation may be desirable (See, e.g., commonly assigned Published U.S. Patent Application No. 2007-0036511, and incorporated herein by reference). While effective in deflecting beams, such prisms are also subject to spectral separation of the light beams, which is problematic where achromatic light transmission is desired, or subject to differential deflection of light beams of differing spectra. In addition, optical components used to convert individual beams into multiple beams likewise require more complex collections of precisely arranged optical components.

The present invention, on the other hand provides simple optical components and/or optical systems that accomplish beam direction substantially without the foregoing disadvantages. In general, the invention relates to simple optical components, such as prisms or optical plates, that are used to effect beam deflection. By using simple optical components, the cost, complexity and space requirements of an optical train can be reduced. Further, in the present invention, such simple optical components are paired with complementary optical components, such as one or more additional prisms or plates, that substantially reverse or otherwise negate any of the foregoing dispersive effects of any individual prism or plate. By “complementary optical component” is meant that a second optical component will have properties of beam transmission that reverse, in part, substantially, or in whole, the undesired effects of a first optical component, such as color separation or differential deflection of beams of different spectra. Thus, where a first optical component introduces a level of spectral separation to a particular beam passed therethrough, a second, complementary optical element will typically at least partially, substantially, or entirely remedy the spectral separation to reintegrate the light beam. Typically, the remedying effects of the complementary component will be substantial, e.g., remedying at least 50%, preferably 75%, and more preferably at least 90% of dispersion, e.g., spectral separation, imparted by the first optical component.

As noted previously, in affecting the redirection of light beams, conventional optical systems typically employ one of two different schemes. First, where a large angle of deflection is possible in view of the space requirements of the overall system, simple mirrors may be employed to redirect light beams as desired. Where space requirements are more stringent and large angle deflections are not desired or not able to be accommodated, multiple mirrors are typically used to provide a smaller ultimate angle of deflection from the original beam.

While prisms have been used in deflection of beams at smaller angles, such prisms can impart spectral separation to the transmitted beam. Where one desires to deflect light achromatically, such separation is problematic. For example, even in conjunction with optical systems that desire to spectrally separate fluorescent optical signals, such systems may require or greatly benefit from the ability to deflect or redirect excitation or illumination light achromatically. As such, optical trains, including those described in Published U.S. Patent Application No. 2007-0036511, that employ separation optics to separate spectrally distinct signal components, may employ achromatic light direction components such as those described herein, for the direction of the excitation light beam(s) or the signal components either before or after spectral separation. As will be appreciated the optical components described herein are particularly useful in the applications described therein.

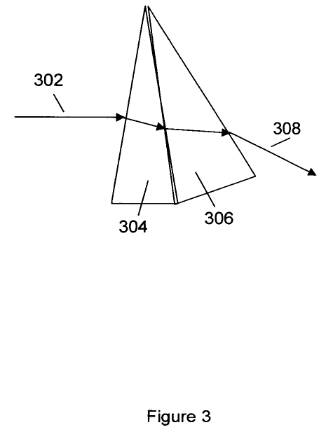

Accordingly, in at least one aspect, two or more transmissive optical elements are employed that each deflect the transmitted beams, but wherein the components provide complementary dispersive properties, e.g., resulting in substantially achromatic light transmission. A schematic illustration of this aspect of the invention is shown in FIG. 3. As shown, the light beam, indicated by arrow 302 is directed through first prism 304, affecting an angular deflection of the beam, but also potentially introducing chromatic separation. By placing a complementary prism 306 adjacent to prism 304, and passing the light through prism 306, the resulting deflected beam 308 is corrected for any chromatic aberrations. As used herein, the spectral impact of a given optical component on the beams passing therethrough are typically referred to as chromatic separation characteristic of the particular component. Thus, the spectral impact of a first optical component or prism in inducing a given spectral separation to a given light beam may be referred to as a first chromatic separation characteristic, while the characteristic of a second complementary component to remedy such separation, may be referred to as a second chromatic separation characteristic.

Provision of complementary prisms in accordance with the invention typically includes selection of appropriate prism materials, e.g., glasses, as well as selection of appropriate angles of deflection for each of the prisms, to accomplish the desired goal. Typically, the amount of wavelength dependent dispersion within a particular prism can be adjusted by selection of prisms comprised of appropriate materials and of appropriate surface angles and sizes.

In addition to adjusting the materials of one or both complementary prisms, one may also adjust the angle of deflection of the two prisms, such that any dispersive effects are minimized, but while also providing the desired deflection of the overall beam.

While illustrated in FIG. 3 and other figures as two optical components (or prisms 304 and 306) that are joined at a single optical interface, it will be appreciated that the two optical elements may be separated in space, and including an air barrier (and thus, multiple optical interfaces), or alternatively, one or more additional optical elements (such as lenses, mirrors, other prisms, or the like), between them.

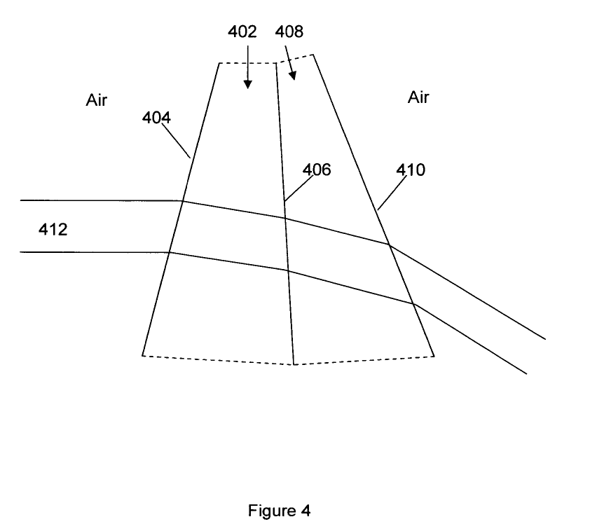

One example of an achromatic prism configuration for affecting light displacement, as described above, is shown in FIG. 4. As shown, a two prism configuration (prisms shown in partial view) is employed using a first prism 402 of Schott BK7 glass, where the first prism surface 404 is provided at an angle of 11.136 degrees relative to perpendicular (to the original axis of the applied light) and a second prism surface 406 at −7.846 degrees relative to perpendicular. A second prism 408 of Schott B270 glass is provided adjacent to the second surface 406 of the first prism 402 and provides a third surface 410 that has a surface angle of −21.490 degrees relative to perpendicular. For three wavelengths of light of interest in a number of fluorescence based biochemical applications, passing from air into the prism set and back into air, as schematically shown by beam 412, the resulting total angle of deflection is substantially the same. In particular, for a laser illumination at 488 nm, the angle of deflection is 24.281 degrees, while for light at 532 nm and 633 nm, the angle of deflection is 24.285 degrees and 24.284 degrees, respectively. As a result, beams at all of these wavelengths will be deflected at substantially the same angle. Depending upon the applied wavelengths and desired deflections, a variety of different prism configurations may be employed.

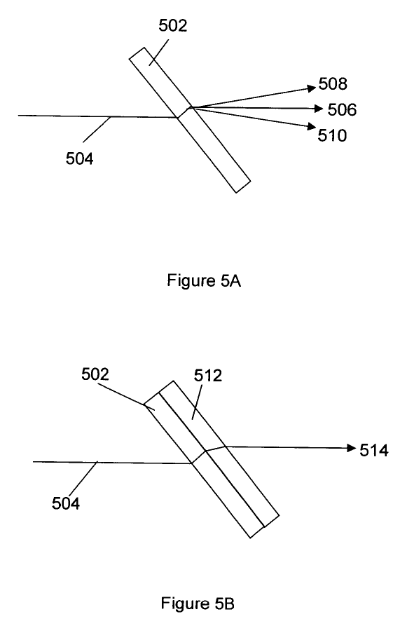

As an alternative to prisms, one may also employ flat plate optics in the redirection or deflection of beams. In particular, as shown in FIG. 5, a flat glass plate 502 may be placed into the path of a light beam 504, e.g., at an angle relative to perpendicular to the optical axis of the beam, in order to translate the beam 506 without inducing an angular change in direction. However, as with prisms, above, differential dispersion of light of different spectra can impart chromatic aberrations in the resulting beam, e.g., color separation, as shown by arrows 508 and 510. Again, however, by employing two or more complementary glass plates, e.g., with complementary dispersive properties, one can translate a beam while substantially reducing or in some cases, eliminating, the amount of chromatic dispersion. This aspect of the invention is schematically illustrated in FIG. 5B.

As with the prisms described above, two or more glass plates may be provided with different, and complementary dispersive properties based upon their compositions and thicknesses. As shown, the beam 504 is again directed at the first glass plate 502. The beam also passes through complementary plate 512 which corrects for a portion or substantially all of any chromatic aberration imparted by plate 502, as indicated by arrow 514. Again, as with the prisms, above, a wide range of such optical glass plates may be obtained commercially from any number of commercial glass suppliers, including, e.g., Corning, Inc. (Corning, N.Y.), and/or Schott North America, Inc. (Elmsford, N.Y.). Depending upon the nature of beam translation and the level of complementarity desired for a given application, one can readily choose among available glass plates based upon the published properties of such plates.

In addition to beam deflection and translation applications, as described above, one may use simplified optical components to achieve other desirable goals for optical detection systems. For example, in a further aspect, the present invention provides a simplified optical component to split one original beam into two or more beams. In preferred aspects, the multiple resulting beams will have substantially similar spectral and intensity characteristics so that they may be applied in multiplexed detection systems, e.g., where uniformity of applied radiation would be desirable. By way of example, multiple beams may generally be desired where one is desirous of illuminating multiple different locations on a substrate, simultaneously. Examples of such applications include, e.g., fluorescence excitation and subsequent detection on biological array substrates, e.g., oligonucleotide arrays, illumination and detection within multiwell assay substrates, illumination and detection of assays carried out in zero mode waveguide arrays, and the like. A variety of other applications may be exploited using the inventions described herein, including, e.g., illumination and reading of printed code elements, e.g., bar codes, and the like.

In accordance with this aspect of the present invention, an optical plate is provided within the path of an illumination beam, and provided with a partially reflective surface coating so that it is able to pass a first portion of the light beam, while reflecting the second, remaining portion. Because the first plate is provided at an angle the second portion is reflected back in a direction orthogonal to the original beam. A second plate or other substrate having a mirrored surface is provided offset from the first plate so as to reflect the second portion of light back toward the surface of the first plate. As with the original beam, a portion of the second portion is passed through the partially reflective surface while the remaining portion is reflected back toward the mirrored surface. This iterative light path then results in multiple resulting beams from an original single beam. Further, by adjusting the angle of each plate relative to the perpendicular of the original beam and relative to each other, one can adjust the spacing between adjacent beams. Further, by adjusting the reflectivity of the semi-reflective surface, e.g., providing gradient of reflectivity over the surface of the first optical plate, one can adjust the intensity of each beam.

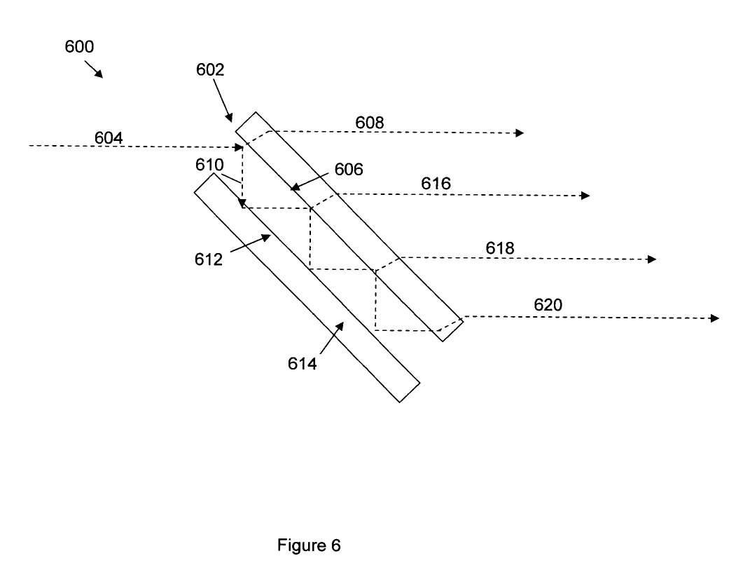

This aspect of the present invention is schematically illustrated in FIG. 6. As shown, a simplified beam splitter 600 is provided in the optical path of a light beam (indicated by arrow 604). The beam splitter 600 includes a first optical plate 602. A first surface 606 of plate 602 is provided to be partially reflective, e.g., using a reflective neutral density coating, such that a first portion (indicated by arrow 608) of the illuminating beam 604 is passed through the first plate 602, while a second portion (indicated by arrow 610), is reflected back. Because the plate 602 is provided at an angle, the reflected portion 610 is directed orthogonally to the optical axis of the original beam 604. A second highly reflective or mirrored surface 612 is provided adjacent to the first plate 602, e.g., disposed upon a second plate 614, to reflect the second portion of the illumination beam back toward the first plate, and the iterative reflection process is repeated. By providing spacing between the two reflective surfaces (606 and 612), one can provide for multiple discrete beams, as illustrated by arrows 608, 616, 618 and 620.

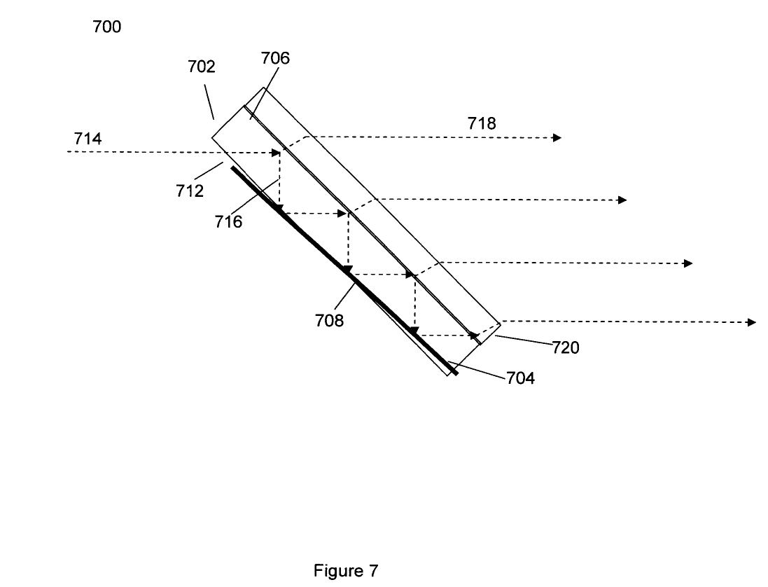

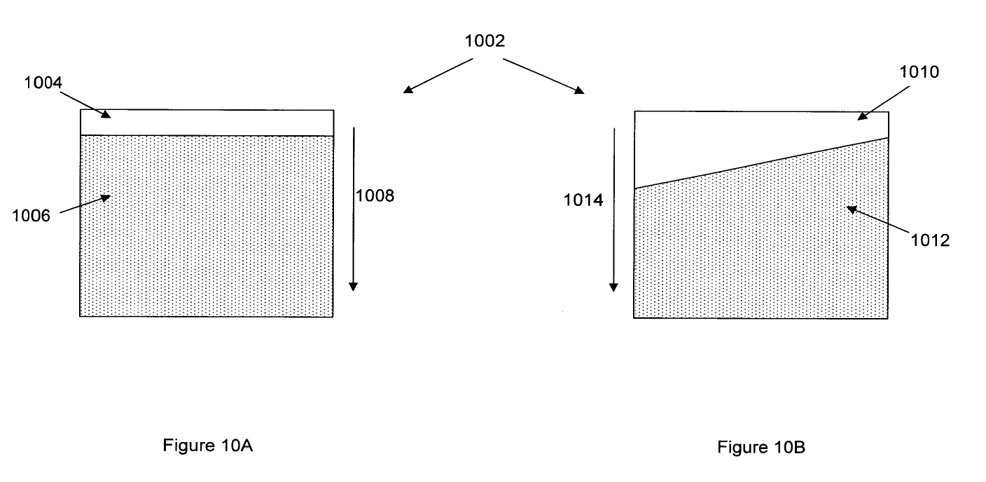

As will be appreciated, by adjusting the spacing between the reflective surfaces, and/or the relative angle between the two surfaces, one can adjust the spacing between adjacent beams emanating from the beam splitting component. In addition to the foregoing, by providing the reflective coating on surface 606 with an appropriate reflective gradient along that surface, one can provide for an equivalent level of passed light with each separated beam. In particular, while a consistent reflective coating could provide for a 10% passage of applied beam, it will be appreciated that with each iteration, the resulting beam will be reduced in intensity, e.g., by 10%. However by adjusting the reflective coating to pass greater amounts of light as a function of position on the surface, e.g., moving down the surface, one can more readily control the light passage so that the resulting beam is of substantially the same intensity. Thus, in preferred aspects, the beam splitter of the invention will, as a result of the variable reflective coating and spacing between the mirrored surface and variable reflective surface, e.g., surfaces 612 and 606, yield a plurality of output beams that have substantially the same intensity as each other. By “substantially the same intensity” is meant that the output beams will typically have intensities that are within 10% of each other, preferably within 5% of each other, 1% of each other, or less. Such a system would not result from a system that employed a constant level of reflective coating. Although shown with mirrored layer 612 extending over the entire surface of plate 602, e.g., to the edge of the first plate 602, it will be appreciated that this mirrored layer may only cover a portion of plate 602, so as to provide a window in plate 602 through which the initial beam may pass, e.g., as shown in FIGS. 7, 10A and 10B.

As will be appreciated, the variable reflective coating may be configured to account for the angle at which the light beam is incident thereupon, e.g., accounting for additional thickness of the coating through which the transmitted beam must pass. As such, where the variably reflective surface is angled relative to the incoming beam, e.g., non-normal to that beam, a thinner coating layer may be provided to achieve the same effective reflectivity as a thicker coating with a normal beam. Additionally, one can conversely rotate the variably reflective surface to provide for the desired level of reflectivity, taking advantage of the increasing or decreasing nominal layer thickness (to the incident light beam) resulting from such rotation.

Variations in variable reflective layer thickness may also be accounted for or corrected by directing the initial beam at different locations on that surface. In particular, one may selectively direct the initial beam to portions of the variably reflective surface that are devoid of problematic aberrations, and that possess the desired level of reflectivity for the initial beam. In some cases, this adjustability may require adjustment of the initial window through which the beam is directed, e.g., window 712 in FIG. 7. In the case of the dual plate beam splitter, this window may be adjusted by sliding the plates relative to each other so as to provide access to a different portion of the variably reflective surface. In the case of single plate options, it may require providing a movable window or a window that varies its position on the mirrored plate over the span of the mirrored plate. An example of the distinction between a fixed window, e.g., as shown in FIG. 7 and a variable window is illustrated in FIGS. 10A and 10B which shows the mirrored plate from a facing view as opposed to the side view shown in FIG. 7. FIG. 10A illustrates the layer 1002 having a fixed location window 1004 in an otherwise mirrored layer 1006, such that there is a relatively small amount of freedom at which one can direct the initial beam with respect to an opposing variable reflective layer, where the reflectivity varies in the orthogonal direction (as shown by arrow 1008).

FIG. 10B on the other hand provides a window 1010 in otherwise mirrored layer 1012, through which one can adjust the initial beams direction along the axis of variable reflectivity (arrow 1014). This additional level of controllability provides an ability to again selectively direct the initial beam at a desired position on the variable reflective layer. As will be appreciated, other variable window configurations may be achieved, e.g., using a slanted slit, varied width slits, or the like.

In this aspect of the invention, additional functionalities may be provided by the first and/or second plate. For example, the first plate may comprise a cylindrical lens having a planar and partially reflective back surface, such that the beams emanating form the components are linearized. Likewise, other focusing, defocusing, translation, deflection, filtering or other functions may be provided by these elements simultaneous with the beam splitting function. In addition, these components may be provided along with additional optical components to provide light direction, separation, focusing, defocusing, linearization or other functions. For example, as noted previously herein, in the event one or more components yield any chromatic aberrations, additional components may be provided having complementary dispersive properties, to yield a substantially achromatic optical system or subsystem.

In addition to the foregoing, in some applications precise spacing between adjacent beams may be an important parameter. As such, in certain cases, the use of two separated plates may require extremely precise positioning of the two plates to precisely maintain their spacing, and as such, maintain the spacing of emitted beams. In particular, if spacing between the two plates, e.g., plates 602 and 614 in FIG. 6, is not maintained constant, the variation will yield a varying spacing between adjacent beams. For example, if such spacing increases distal to the point of entry of the initial beam (arrow 604), then the spacing between the emitted beams will increase as well. In some cases, it may be desirable to provide for variable spacing of the beams by providing the two plates at different angles, e.g., providing them at non-parallel orientations. For example, if the mirrored and variable reflective surfaces are provided tilted, relative to each other, each subsequent beam emanating from the beam splitter will leave at an angle that is 2× the tilt angle relative to the previous beam. This converging beam arrangement may be employed to direct multiple beams in a number of advantageous ways. For example, by providing converging multiple beams, one can position the beam splitter such that all of the emanating beams converge at a rear aperture of an objective lens, and provide multiple independent beams in the focal plane of the objective, e.g., on a substrate. This allows direction of the multiple beams into an objective without the need for additional complex optical components, e.g., mirrors and/or lenses to direct the different beams into the objective at converging angles.

Accordingly, in an alternative and simplified approach, one may provide both the semi-reflective coating or layer upon the same plate as the mirrored coating, so that the constant thickness of the glass provides the relevant spacing, e.g., the iterative reflections are carried out within a glass plate of substantially more uniform thickness. This aspect of the invention is illustrated in FIG. 7. As shown, the beam splitter 700 includes a first optical plate 702, e.g., comprised of glass, and having a first surface 704 and a second surface 706. Surface 706 includes the variable reflective surface, e.g., using a variable density reflective coating. Surface 704, on the other hand includes a mirrored surface 708, having its reflective surface directed into the interior of plate 702. The mirrored surface 708 extends over a portion of surface 704, but leaves a portion uncovered, to provide a window 712 for receiving the original beam 714. As shown, the original beam 714 enters into plate 702 through the window 712, and impinges upon the variably reflective surface 706. A portion of beam 714 is reflected by the variable reflective surface 706 (shown by arrow 716), while the remainder of the beam (shown by arrow 718) is transmitted through the surface 706. The reflected portion 716 of the beam then impinges upon and is reflected by mirrored surface 708, and again impinges upon a different portion of variably reflective surface 706, again transmitting a portion of the beam and reflecting a portion of the beam back into mirrored surface 708. As shown in FIG. 6, multiple beams are thus generated from a single original beam. However, unlike the beam splitter shown in FIG. 6, the beam splitter shown in FIG. 7 provides little spacing variation between the reflective surfaces, as a result of the ability to provide a single plate with substantially uniform thickness. Additionally, as with the various aspects described above, any chromatic variations resulting from the transmission of the light by plate 702, may be remedied through the inclusion of a complementary optical plate, e.g., optional plate 720.

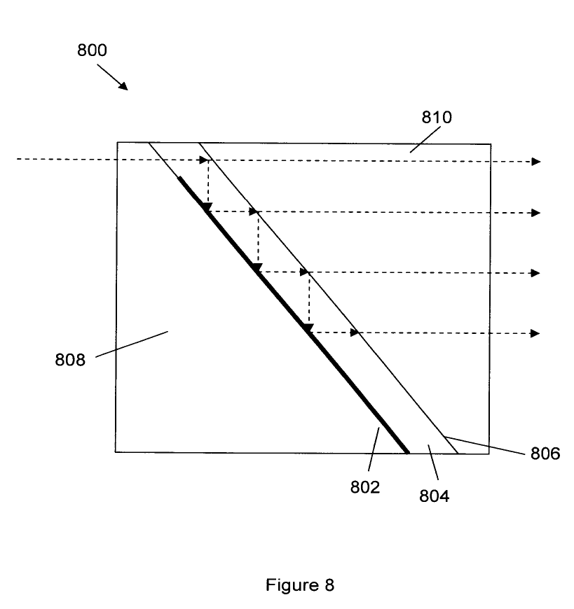

In an alternative arrangement, the beam splitting plate may be incorporated into a single monolithic block, such that the angle of incidence of the original beam, and thus, the spacing of the emitted beams, may be predefined, requiring little adjustment in operation. Additionally, the original beam impinges upon the propagating medium, e.g., the monolithic block, at an angle that is substantially normal to the plane of the surface of the block, allowing one the ability to adjust both spacing and angle of the reflective surfaces during the manufacturing process without regard for any effects that might arise from the incident beam contacting the angled plate. This provides substantially greater flexibility in selection of spacing and angle while also providing ease of manufacturing. A schematic illustration of this aspect of the invention is shown in FIG. 8. As shown, a monolithic optical block 800 is provided with internal layers 802-806 sandwiched between block components 808 and 810, that accomplish the same goals as the beam splitter in FIG. 7. In particular, layer 802 provides the mirrored layer comparable to mirrored surface 708 in FIG. 7, while layer 806 provides the same semi-reflective functionality of surface 706 in FIG. 7. Likewise, layer 804 operates as the propagating medium for the reflected light between layers 802 and 806, as is the case for optical plate 702 in FIG. 7. In operation, as shown by the arrows, a beam is directed through the end of the block 800 at semi-reflective layer 806. As with FIG. 7, this may be facilitated by the presence of a window in mirrored layer 802 (rendering it a partially mirrored layer). While a portion of the beam is transmitted by layer 806, the remainder is reflected back toward partially mirrored layer 802, and the propagation and splitting of the beam continues as in FIG. 7. Again, as described above, any chromatic aberrations may be remedied through the use of complementary components either within monolithic block 800, e.g., incorporated into one or both of block components 808 and 810. Alternatively, the complementary components may be separate from the block 800.

The optical components described above are typically incorporated into systems and subsystems that will generally include illumination systems or light sources. In preferred aspects, the light sources typically include one or more light sources directed through the optical components described herein, optionally before or after being directed through additional optical components. In particular, in addition to light sources, the systems of the invention typically include additional light direction and manipulation components such as lenses, mirrors, prisms and/or plates, e.g., as described above, filters, and the like. In addition, such systems, when used in the optical analysis of materials, reactions, or other processes, will include observed components which may include reaction wells, substrate surfaces including materials of interest or otherwise. Such systems will also typically include signal collection and manipulation optics as well as detectors, and data storage and processing components, such as a computer.

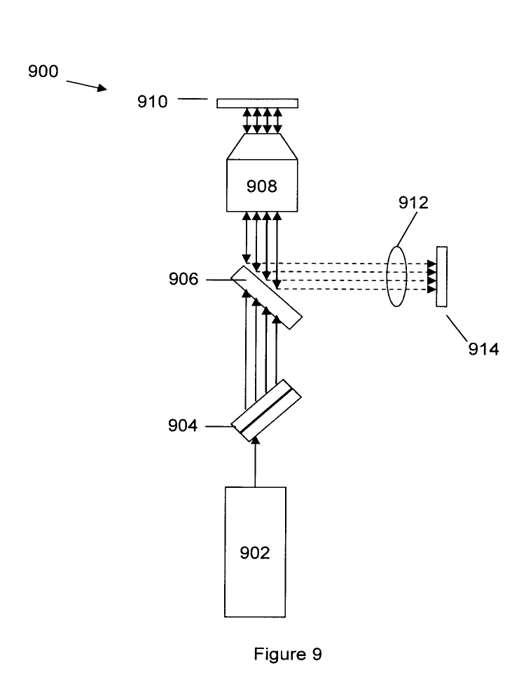

One example of a system employing a beam splitter of the invention in the context of a fluorescence based assay system is illustrated in FIG. 9. As shown, the system 900 includes a light source such as laser 902. The laser is positioned to direct the beam into beam splitter 904, e.g., such as beam splitter 800 shown in FIG. 8. The beams emanating from beam splitter 904 are then passed through an optical train that includes, e.g., dichroic 906 that passes light of the wavelength of the laser light, but reflects light at the wavelength of the fluorescent material. The light is then passed through objective 908, and directed at substrate 910 upon which is provided a fluorescent material for which illuminated analysis is desired. Fluorescent signals emanating from substrate 910 are then collected back through objective 908 and reflected by dichroic 906, as shown by the dashed arrows, and directed via focusing lens 912 toward detector 914, which in preferred aspects, e.g., where large areas are being analyzed, includes, e.g., an array detector such as a CCD, EMCCD, ICCD, or diode array detector. As will be appreciated, additional optical components will typically be employed, e.g., to provide the multiple beams entering the objective to enter at converging angles, so as to be focused on multiple positions on a substrate.

As will be appreciated, the optical modules of the invention may be employed alone or in combination with the various embodiments described herein. In particular, the optical modules are preferably employed as one or more optical components in an optical train in an analytical optical system, such as a fluorescent signal detection system, where these components are preferably employed in the illumination path of such fluorescent detection systems. In particular, these components are preferably employed in directing excitation light from an excitation light source, such as a laser or other appropriate source, to one or more discrete locations (also referred to herein as “analytical regions”) on the surface of an analytical substrate, which locations include sources of fluorescent signals, e.g., as described in the applications noted elsewhere herein.

Likewise, the use of these optical modules is also encompassed in the invention. In particular, the optical modules may be employed in methods of directing individual or multiple light beams at analytical substrates, as described elsewhere herein.

As noted previously, the optical components and systems of the invention are particularly useful in analyzing materials, reactions or otherwise that rely upon illumination of same. In particular, these systems are useful in illuminating large areas of substrates or materials in order to generate fluorescent responses. Of particular interest are analyses of chemical, biochemical and biological reactions that are carried out in discrete locations of substrates, multiwell plates, arrays or the like. Such analyses include molecular interactions, enzymatic reactions, analyte quantitation, and the like, such as are described in, e.g., U.S. Pat. Nos. 7,056,661, 7,052,847, 7,033,764, 7,056,676, and in nucleic acid arrays as described in U.S. Pat. Nos. 5,143,854, 5,405,783 and related patents, and GeneChip® systems from Affymetrix, Inc., as well as for use in conjunction with microfluidic analytical systems such as are available from Caliper Life Sciences and Agilent Technologies. All of the foregoing patents are incorporated herein by reference in their entirety for all purposes.

Although described in some detail for purposes of illustration, it will be readily appreciated that a number of variations known or appreciated by those of skill in the art may be practiced within the scope of present invention. To the extent not already expressly incorporated herein, all published references and patent documents referred to in this disclosure are incorporated herein by reference in their entirety for all purposes

What is claimed:

1. An optical module, comprising:
a first optical component configured to redirect a beam of light passed therethrough and having a first chromatic separation characteristic; and
a second optical component adjacent the first optical component, and having a second chromatic separation characteristic that is complementary to the first chromatic separation characteristic, such that chromatic separation of the beam of light imparted by the first chromatic separation characteristic of the first optical component is substantially eliminated by the second chromatic separation characteristic of the second optical component.

2. The optical module of claim 1, wherein at least one of the first and second optical components comprises a prism.

3. The optical module of claim 1, wherein at least one of the first and second optical components comprises a planar optical plate.

4. The optical module of claim 1, wherein the first and second optical modules comprise prisms.

5. The optical module of claim 1, wherein the first and second optical modules comprise planar optical plates

6. The optical module of claim 1, wherein the first and second optical components are adjoined at a first optical interface.

7. The optical module of claim 1, wherein the first and second optical components are disposed in an integrated optical block.

8. An optical system, comprising:
an illumination light source;
an analytical substrate;
an optical train configured to direct illumination light from the illumination light source to at least a first location on the analytical substrate, the optical train comprising:
a first optical component configured to redirect a beam of light from the illumination light source directed through the first optical component, and having a first chromatic separation characteristic; and
a second optical component adjacent the first optical component, and having a second chromatic separation characteristic that is complementary to the first chromatic separation characteristic, such that chromatic separation of the beam of light imparted by the first chromatic separation characteristic of the first optical component is substantially eliminated by the second chromatic separation characteristic of the second optical component

9. The system of claim 8, further comprising an optical detector, and wherein the substrate comprises at least a first analytical region, and the optical train comprises optics for collecting optical signals from the first analytical region and directing the optical signals to the optical detector.

10. The system of claim 9, wherein the at least first analytical region comprises at least a first source of fluorescent optical signals.

11. The system of claim 9, wherein the substrate comprises a plurality of discrete analytical regions, and the optical train is configured to direct a plurality of illumination light beams at the plurality of analytical regions on the substrate.

12. The system of claim 11, wherein the optical train comprises a light beam multiplication module comprising:
a first variable reflective surface;
a first mirrored surface spaced from and opposing the first variable reflective surface;
wherein when a first light beam is directed at a first position upon the first variable reflective surface, a portion of the light beam is reflected from the variable reflective surface to the mirrored surface and reflected back from the mirrored surface in a second beam to the variable reflective surface at a second position, and a portion of the first beam and second beams are transmitted through the variable reflective surface in first and second emanating beams, wherein the first and second emanating beams are of substantially the same intensity.

13. An optical module comprising:
a first variable reflective surface;
a first mirrored surface spaced from and opposing the first variable reflective surface;
wherein when a first light beam is directed at a first position upon the first variable reflective surface, a portion of the light beam is reflected from the variable reflective surface to the mirrored surface and reflected back from the mirrored surface in a second beam to the variable reflective surface at a second position, and a portion of the first beam and second beams are transmitted through the variable reflective surface in first and second emanating beams, wherein the first and second emanating beams are of substantially the same intensity.

14. The optical module of claim 13, wherein the first variable reflective surface and first mirrored surface are disposed upon first and second optical plates, respectively, the first and second optical plates being spaced apart from each other and positioned so that the variable reflective surface and mirrored surface are opposing.

15. The optical module of claim 13, wherein the first variable reflective surface and first mirrored surface are disposed upon opposite surfaces of a first optical plate such that the first variable reflective surface and first mirrored surface are spaced apart by a thickness of the first optical plate.

16. The optical module of claim 13, wherein the first variable reflective surface and first mirrored surfaces are disposed within a monolithic optical block and positioned within the block to be spaced apart from and opposing each other.

17. An optical system, comprising:
an illumination light source;
an analytical substrate;
an optical train configured to direct illumination light from the illumination light source to a plurality of locations on the analytical substrate, the optical train comprising an optical module that comprises:
a first variable reflective surface; and
a first mirrored surface spaced from and opposing the first variable reflective surface;
wherein when a first light beam from the illumination light source is directed at a first position upon the first variable reflective surface, a portion of the light beam is reflected from the variable reflective surface to the mirrored surface and reflected back from the mirrored surface in a second beam to the variable reflective surface at a second position, and a portion of the first beam and second beams are transmitted through the variable reflective surface in first and second emanating beams, wherein the first and second emanating beams are of substantially the same intensity, and are directed at the plurality of locations on the analytical substrate.

18. The optical system of claim 17, wherein each of the plurality of locations on the analytical substrate comprises a source of fluorescent signals, and the system further comprises an optical detector, and the optical train further comprises collection optics for collecting fluorescent signals from the plurality of locations on the analytical substrate, and transmission optics for transmitting the fluorescent signals to the optical detector.

19. The optical system of claim 17, wherein the optical train further comprises an optical module for redirection of a beam of light from the illumination light source that comprises:
a first optical component configured to redirect a beam of light passed therethrough and having a first chromatic separation characteristic; and
a second optical component adjacent the first optical component, and having a second chromatic separation characteristic that is complementary to the first chromatic separation characteristic, such that chromatic separation of the beam of light imparted by the first chromatic separation characteristic of the first optical component is substantially eliminated by the second chromatic separation characteristic of the second optical component.

20. A method of achromatically redirecting a path of a light beam, comprising:
directing the light beam through a first optical component that is configured to redirect the light beam by a first deflection angle to yield a first deflected light beam, wherein the first optical component has a first chromatic separation characteristic; and
directing the first deflected light beam through a second optical component adjacent the first optical component, and having a second chromatic separation characteristic that is complementary to the first chromatic separation characteristic, such that chromatic separation of the deflected light beam imparted by the first chromatic separation characteristic of the first optical component is substantially eliminated by the second chromatic separation characteristic of the second optical component, to yield a second deflected light beam.

21. A method of multiplying a first light beam into a plurality of light beams, comprising:
directing the first light beam through a first optical component that comprises a first variable reflective surface and a first mirrored surface spaced from and opposing the first variable reflective surface;
wherein when the first light beam is directed at a first position upon the first variable reflective surface, a portion of the first light beam is reflected from the variable reflective surface to the mirrored surface and reflected back from the mirrored surface in a second beam to the variable reflective surface at a second position, and a portion of the first beam and second beams are transmitted through the variable reflective surface in first and second emanating beams, wherein the first and second emanating beams are of substantially the same intensity.

22. The method of claim 21, further comprising directing the at least first and second emanating beams to different regions on an analytical substrate
